(19) United States
(12) Patent Application Publication
(10) Pub. No.: US 2004/0002358 A1
(43) Pub. Date: Jan. 1, 2004

(54) Receiver unit of a terminal device

(75) Inventor: Doo-Hwan Jo, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/607,560

(22) Filed: Jun. 27, 2003

(30) Foreign Application Priority Data
Jun. 28, 2002 (KR) 37024/2002

(51) Int. Cl. H04M 1/00

(52) U.S. Cl. 455/550.1; 455/575.1

(57) ABSTRACT

An electronic device includes a sound generator, a housing having a plurality of holes, and a sound controller between the sound generator and housing. The sound controller controls discharge of sound from the sound generator through the holes in the housing. The discharge of sound is preferably controlled based on a predetermined sound leakage pattern. The sound controller includes a leakage member having a plurality of holes arranged based on the sound leakage pattern. The leakage member may be arranged so that some of the holes are coincident with sound holes in a casing of the devices, while other holes are not in alignment with the casing holes. As a result, sound leakage is generated which substantially reduces sound volume differences when the electronic device is used at varying distances from a user. The electronic device may, for example, be a mobile terminal.

### BACKGROUND OF THE INVENTION

1. Field of the Invention

The present invention relates to a terminal device, and more particularly to a receiver unit of a terminal device with a controlled-volume output.

2. Background of the Related Art

Terminal devices generally include a Printed Circuit Board (PCB) inserted inside a main body, an operation button for performing various functions, a microphone for inputting the voice of a user, a receiver unit by which a user receives a sound, and a liquid crystal screen for displaying various information.

FIG. 1 shows a front view of the terminal and FIG. 2 is a partial sectional view showing the manner in which a receiver unit is mounted in a conventional. In these figures, a terminal main body 106 consists of an outer case 102 and an inner case 104, receiver unit 108 inserted in the main body 106 for generating a sound, one or more sound discharge holes 110 formed to penetrate the inner case and discharge sound generated from the receiver unit, and a sealing member 112 mounted between the front side of the receiver unit and the inner case for preventing leakage of sound generated from the receiver unit to areas other than the sound discharge hole. In addition to these features, a damper 114 is installed between the outer case 102 and the upper side of the receiver unit 108, and the sealing member 112 is attached hermetically between the lower side of the receiver unit 108 and the inner case 104 in order to prevent sound from the receiver unit from leaking to areas other than the sound discharge hole 110.

In the conventional receiver unit, sound is generated inside the receiver unit 108 when an electric signal is applied. The sound is transferred to the user through the sound discharge hole 110 formed in the inner case 104. Because space between the receiver unit 108 and inner case 104 is sealed by sealing member 112, the sound generated from the receiver unit 108 does not leak outside and is transferred to the user through the sound discharge hole 110. After sound is discharged through the sound discharge hole 110, it is leaked in every direction. A sound volume transferred to the user therefore differs depending on a reception distance between the terminal device and the user. This effect will now be described in greater detail with reference to FIGS. 3 and 4.

FIG. 3 is a graph showing how sound volume characteristics vary based on a reception distance between a user and a receiver unit of the conventional terminal device. In this graph, Curve P is obtained when a reception distance between the terminal device and the user is 0, and Curve Q is obtained when a reception distance between the terminal device and the user is 1 mm. This graph also demonstrates that when a reception distance between the terminal device and the user is 0 under conditions where the frequency discharged from the receiver is 1 Khz, a measured sound volume is 104.4 dB is obtained as indicated by point L in the graph. This signifies a sound volume measured based on the assumption that the terminal device is attached to the eat of the user and there is no sound leakage.

The graph also shows that the measured sound volume is 86.2 dB when a reception distance is 1 mm and the frequency discharged from the receiver is 1 Khz as indicated by point M in the graph. This signifies that more of the sound volume is transferred to the user, taking into consideration that sound leakage takes place at varying degrees among basis for users. The graph therefore shows that the sound volume difference between the case where the reception distance is 0 and the case where the reception distance is 1 mm is about 18.2 dB, which is a significant difference. This translates into at least the following undesirable effects.

In the conventional terminal device, the sound volume difference that a user may feel may vary from user to user, and significantly depends on the reception distance between the terminal device and the user. As a result, the use conditions and preferences of every user may not be satisfied. Put differently, the sound volume of the receiver is set in conformity to the condition that most users generally uses it, it can not satisfy various use conditions of users.

### SUMMARY OF THE INVENTION

An object of the invention is to solve at least the above problems and/or disadvantages and to provide at least the advantages described hereinafter.

Another object of the present invention is to provide a receiver unit of a terminal device, which minimizes a sound volume change depending on a reception distance between a terminal device and a user.

To achieve these and other objects and advantages the present invention provides a receiver unit of a terminal device including: a main body which includes an outer case forming an outer portion and an inner case coupled with the outer case and having a plurality of sound discharge holes; a receiver disposed inside the main body for generating a sound; and a sound leakage unit disposed between the receiver and the inner case for leaking a portion of the sound generated from the receiver before being discharged through the sound discharge hole.

In the receiver unit of a terminal device of the present invention, a plurality of leakage holes are formed between a front side of the receiver and an inner side of the inner case in order to leak a sound therethrough in a circumferential direction.

In the receiver unit of a terminal device of the present invention, the sound leakage unit includes leakage holes formed at regular intervals in a circumferential direction of the lower housing of the receiver, and a plurality of protrusions formed protruded with a certain width.

In the receiver unit of a terminal device of the present invention, the sound leakage unit of the receiver unit has a predetermined width and is formed in a cylindrical shape with a plurality of leakage holes in a circumferential direction. Sides of the leakage unit are respectively attached to a lower housing of the receiver and the inner case.

### BRIEF DESCRIPTION OF THE DRAWINGS

FIG. 1 is a front view of the terminal device;

FIG. 2 is a cross-sectional view taken along section line II-II of FIG. 1 showing a receiver unit of a terminal device in accordance with a conventional art;

FIG. 3 is a graph showing sound volume characteristics according to a reception distance between a user of the receiver unit of the terminal device and the terminal in accordance with the conventional art;

FIG. 4 is a diagram showing sound volume characteristics according to a reception distance between the user of the receiver unit of the terminal device and the terminal in accordance with the conventional art;

FIG. 5 is a partial sectional view showing a receiver unit of a terminal device in accordance with one embodiment of the present invention,

FIG. 6 is a perspective view of one type of leakage member in accordance with one embodiment of the present invention.

FIG. 7 is a partial sectional view showing a receiver unit of a terminal device in accordance with another embodiment of the present invention;

FIG. 8 is a graph showing sound volume characteristics depending on a reception distance between the user of the receiver unit of the terminal device and the terminal in accordance with the present invention; and

FIG. 9 is a diagram showing sound volume characteristics depending on a reception distance between the user of the receiver unit of the terminal device and the terminal in accordance with the present invention.

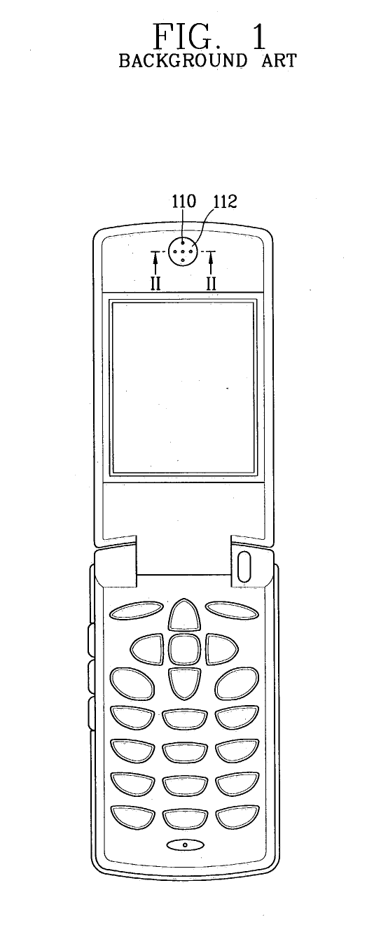

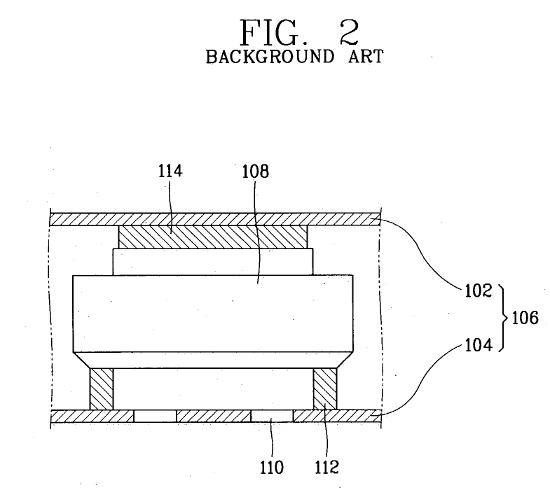

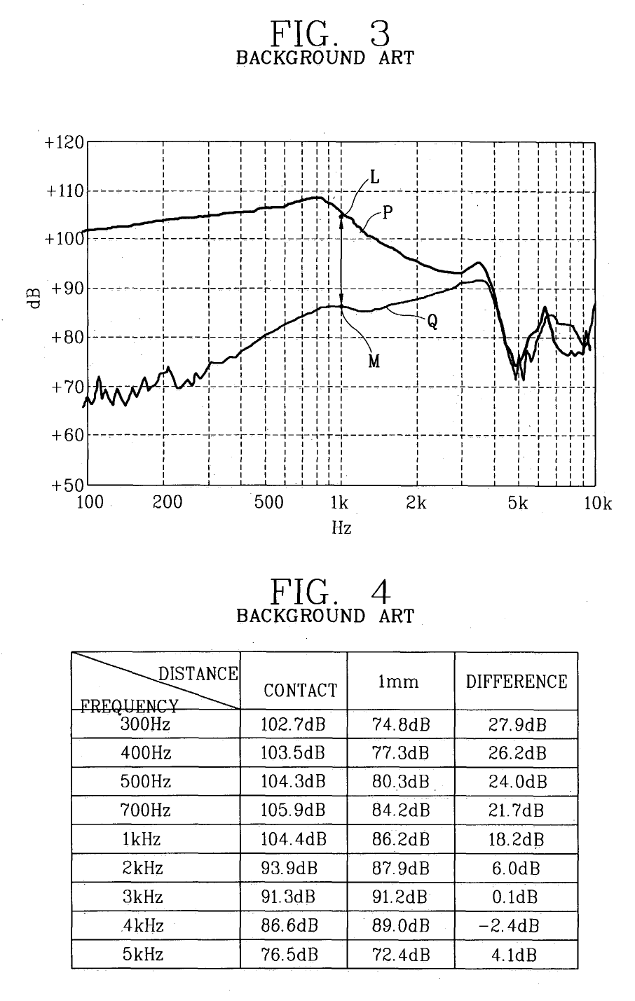

### DETAILED DESCRIPTION OF PREFERRED EMBODIMENTS

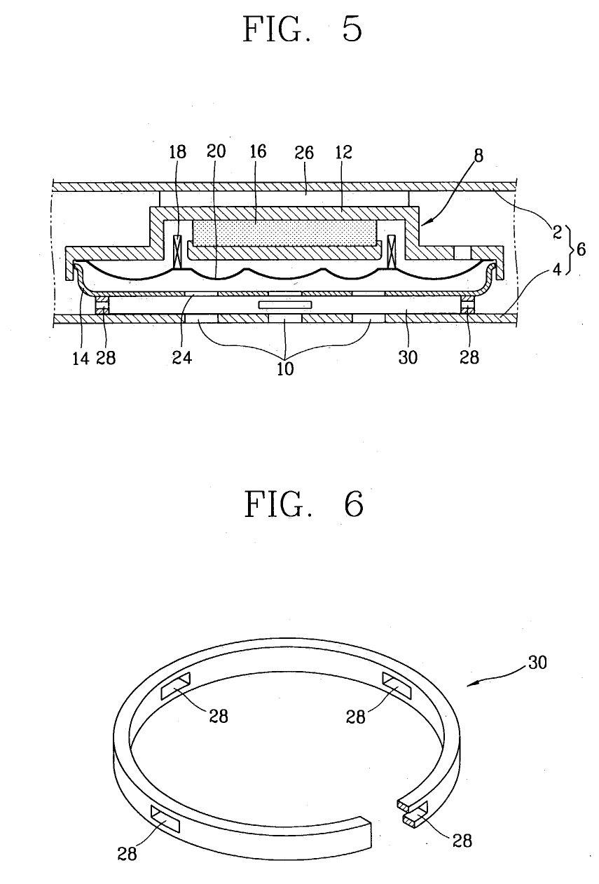

FIG. 5 is a sectional view of a receiver unit of a terminal device in accordance with one embodiment of the present invention. The receiver unit includes a main body 6 having an outer case 2 and an inner case 4 coupled with the outer case 2. The main body 6 also includes a liquid crystal screen and a microphone (neither of which are shown). Also, a receiver 8 is installed inside the main body 6 for generating sound and sound discharge holes 10 are formed in the inner case 4 for outwardly discharging sound generated by the receiver 8. A sound leakage unit is disposed between the receiver 8 and the inner case 4 for leaking a portion of the sound generated from the receiver 8. The terminal device of the present invention may be adapted for use in any one of a variety of terminals including but not limited to mobile terminals, wired terminals, wireless terminals, or any other electronic device which includes a receiver or sound generator.

The receiver 8 includes an upper housing 12 and a lower housing 14 mounted in spaced relation with the upper housing 12 and having a plurality of sound paths 24 formed in a preferably circumferential direction for discharging sound. A magnet 16, a coil 18, and a vibration plate 20 are mounted in the space between the upper and lower housings 12, 14 for generating sound when current is applied thereto. A damper 26 maybe attached between the upper housing 12 of the receiver 8 and the outer case 2.

The sound leakage unit includes a leakage member 30 which is preferably cylindrical in shape and installed between the circumferential surface of the lower housing 14 of the receiver 8 and an inner circumferential surface of the inner case 4. The leakage member 30 has a plurality of leakage holes 28 which are preferably formed in a circumferential direction.

FIG. 6 is a perspective view of one type of leakage member 30 of the present invention. As shown, the leakage member 30 is preferably formed in a cylindrical shape with a thickness so as to maintain a desired space between the lower housing 14 and the inner case 4 of the receiver 8. In this exemplary construction, the leakage holes 28 are arranged in a regularly spaced pattern although other patterns are possible. Also, the holes 28 are shown as being generally slot shape, however, the holes 28 may be in others shapes if desired. One side of the leakage member 30 is fixed to a circumferential side of the lower housing 14 and the other side is fixed at the inner side of the inner case 4. The leakage member 30 may be attached to or held between the lower housing 14 and inner case 4 using any one of a variety of known techniques or methods.

Typically, many users use terminals at a distance of about 1 mm. As a guide, a size and form of the holes 28 in the leakage member 30 may be based on the amount of sound leakage that exists when the distance between the user and terminal device is about 1 mm. However, other distances may be used for purposes of determining the size, shape, and form of the leakage holes.

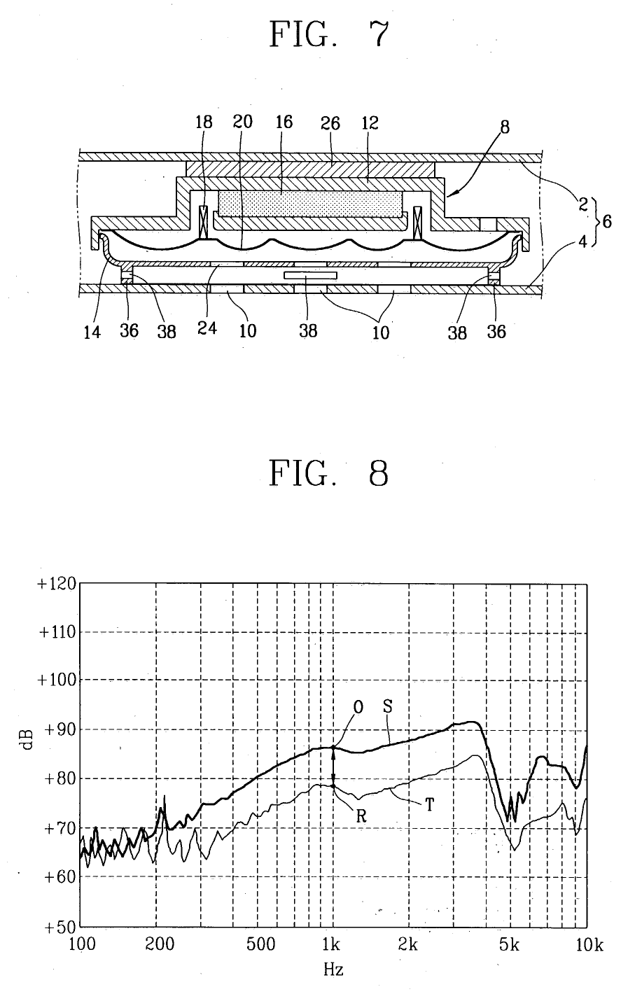

FIG. 7 shows another embodiment, of the sound leakage unit of the present invention. Where applicable, like reference numerals have been used. In this embodiment, protrusions 36 are formed in a sound leakage member 40 with a desired interval in a preferably circumferential direction in the front side of lower housing 14 of the receiver to facilitate fabrication. At this time, at least one leakage hole 38 is formed in a space between the protrusions 36 to leak sound. In addition to this leakage member 40, the sound leakage unit may maintain a certain space between the front side of the lower housing 14 and the inner case 4 and can be fabricated in any form as long as it allows a plurality of leakage holes to be formed in a desired (e.g., circumferential) direction.

In the various embodiments of the receiver unit of the terminal device of the present invention, when power is applied to the receiver, sound is generated as coil 18 and vibration plate 20 interact. The sound is discharged through sound paths 24 formed at the lower housing 14. A portion of the sound discharged through the sound paths 24 is leaked through the leakage holes (28 in FIG. 5) and (38 in FIG. 7) and then outwardly discharged through the sound discharge holes 10 of the inner case 4. Therefore, a change in the sound volume discharged through the sound discharge holes 10 of the inner case 4 can be minimized when it is transmitted to the user.

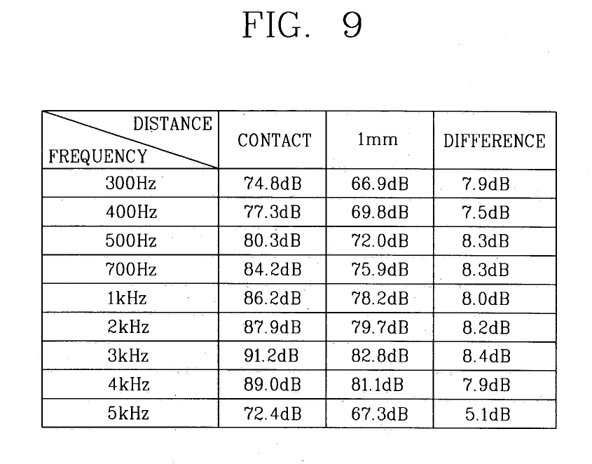

This minimization of sound is, at least in part, a function of the distance between the user and terminal. For example, a large difference in sound volume exits as a result of leakage within a certain distance range. On the other hand, a small difference in sound volume exists when this range goes beyond a certain distance as noted by testing data set forth in FIGS. 8 and 9 (discussed in greater detail below).

Thus, in the present invention, sound generated from the receiver is leaked before it is transmitted to the user. As a result, sound can be transmitted to the user from the point in time when leakage is completed. Thus, regardless of a change in the reception distance between the user and terminal, the change in the sound volume transmitted to the user can be minimized in accordance with the present invention.

Operation of the receiver unit will now be described in detail with reference to the graph of FIG. 8 and the diagram of FIG. 9. Curve S of the graph in FIG. 8 is obtained when the distance between the user and the terminal is 0, and Curve T is obtained when the distance between the user and the terminal is 1 mm. When the frequency discharged from the receiver is 1 KHz and a reception distance between the user and the terminal is 0, sound volume is 86.2 dB as indicated by Point O. If a reception distance between the user and the terminal is 1 mm, a sound volume is 78.2 dB as indicated by Point R, the resulting sound volume difference is therefore 8.0 dB, which is significantly smaller than the Conventional Art.

Specifically, compared with the conventional art, as shown in FIG. 3, when the reception distance is 0 at a 1 KHz discharge frequency the sound volume is 104.4 dB, and when the reception distance is 1 mm the sound volume is 86.2 bB, which results in a difference of 18.2 dB. Therefore, it is noted that a sound volume difference based on the reception distance is considerably smaller by adopting the present invention.

According to a measurement result obtained even at a different discharge frequency band generated from the receiver, a sound volume difference according to a reception distance can be remarkably small when adopting the receiver unit of the present invention, compared to that of the conventional art.

As so far described, the receiver unit of the terminal device of the present invention has the following advantages.

A sound leakage unit is installed between the front side of the receiver and the inner side of the inner case in order to leak a portion of the sound generated from the receiver. Accordingly, after the sound generated from the receiver is completely leaked within a certain range, it is transferred to the user through the sound discharge hole. Thus, the change in the sound volume according to the change in the reception distance between the terminal and, the user can be minimized.

In addition, the change in the sound volume transferred to the user according to the change in the reception distance can be minimized, so that the receiver unit can be easily and conveniently used and satisfy user's various desires.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. An electronic device, comprising:
a sound generator;
a housing having a plurality of holes; and
a sound controller between the sound generator and housing,
wherein the sound controller controls discharge of sound from the sound generator through the holes in the housing.

2. The electronic device of claim 1, wherein the sound controller controls the discharge of sound through the holes based on a predetermined sound leakage pattern.

3. The electronic device of claim 2, wherein the predetermined sound leakage pattern increases uniformity of output sound volume within a predetermined distance range from the device.

4. The electronic device of claim 1, wherein the sound controller includes:
a leakage member having a plurality of holes,
wherein a portion of the holes in the leakage member are aligned with the holes in the housing and wherein other holes in the housing are blocked by the leakage member.

5. The electronic device of claim 4, wherein the holes in the leakage member are arranged relative to the holes in the housing to leak sound in a circumferential direction.

6. The electronic device of claim 4, wherein the holes in the leakage member are arranged at regular intervals in a circumferential direction.

7. The electronic device of claim 4, wherein the leakage member is cylindrical in shape and wherein the holes in the leakage member are in a circumferential direction.

8. The electronic device of claim 4, wherein the holes in the housing and the holes in the leakage member are arranged in a same pattern.

9. The electronic device of claim 8, wherein said pattern is a circular pattern.

10. The electronic device of claim 4, wherein a spacing between the sound generator and housing corresponds to a thickness of the leakage member.

11. The electronic device of claim 4, wherein the sound generator includes at least one spacing member which controls a spacing between the sound generator and housing.

12. The electronic device of claim 4, wherein the sound generator includes a wall having a plurality of holes.

13. The electronic device of claim 12, wherein the holes in said wall are coincident with the holes in the housing.

14. The electronic device of claim 1, wherein the electronic device is a communications terminal.

15. The electronic device of claim 14, wherein the communications terminal is a mobile communications terminal.

16. A communications terminal, comprising:
a housing;
a receiver within the housing; and
a sound controller between the receiver and housing,
wherein the sound controller controls discharge of sound from the receiver through holes in the housing.

17. The terminal of claim 16, wherein the sound controller controls the discharge of sound through the holes based on a predetermined sound leakage pattern.

18. The terminal of claim 17, wherein the predetermined sound leakage pattern increases uniformity of output sound volume within a predetermined distance range from the terminal.

19. The terminal of claim 16, wherein the sound controller includes:
a leakage member having a plurality of holes,
wherein a portion of the holes in the leakage member are aligned with the holes in the housing and wherein other holes in the housing are blocked by the leakage member.

20. The terminal of claim 19, wherein the holes in the leakage member are arranged relative to the holes in the housing to leak sound in a circumferential direction.

21. The terminal of claim 19, wherein the holes in the leakage member are arranged at regular intervals in a circumferential direction.

22. The terminal of claim 19, wherein the leakage member is cylindrical in shape and wherein the holes in the leakage member are in a circumferential direction.

23. The terminal of claim 19, wherein the holes in the housing and the holes in the leakage member are arranged in a same pattern.

24. The terminal of claim 23, wherein said pattern is a circular pattern.

25. The terminal of claim 19, wherein a spacing between the receiver and housing corresponds to a thickness of the leakage member.

26. The terminal of claim 19, wherein the sound generator includes at least one spacing member which controls a spacing between the receiver and housing.

27. The terminal of claim 19, wherein the receiver includes a wall having a plurality of holes.

28. The terminal of claim 27, wherein the holes in said wall are coincident with the holes in the housing.

29. A method for controlling sound in a communications terminal, comprising:
generating sound; and
controlling discharge of the sound through holes in a housing of the terminal.

30. The method of claim 29, wherein the controlling step includes:
controlling the discharge of sound through the holes based on a predetermined sound leakage pattern.

31. The method of claim 30, wherein the predetermined sound leakage pattern increases uniformity of output sound volume within a predetermined distance range from the terminal.

32. The method of claim 29, wherein the controlling step includes:
passing the sound only through a predetermined portion of the holes in the housing.

33. The method of claim 32, wherein the controlling step includes:
passing the sound in a circumferential direction through said predetermined portion of the holes.

34. The method of claim 32, wherein said predetermined portion of the holes are arranged at regular intervals in a circumferential direction.

35. A receiver unit of a terminal device comprising:
a main body consisting of an outer case forming an outer portion and an inner case coupled with the outer case and having a plurality of sound discharge holes;
a receiver disposed inside the main body and generating a sound; and
a sound leakage unit disposed between the receiver and the inner case and leaking a portion of the sound generated from the receiver before being discharged through the sound discharge hole.

36. The receiver unit of claim 35, wherein a plurality of leakage holes are formed between a front side of the receiver and an inner side of the inner case in order to leak a sound therethrough in a circumferential direction.

37. The receiver unit of claim 35, wherein the sound leakage unit includes leakage holes formed at regular intervals in a circumferential direction of the lower housing of the receiver, and a plurality of protrusions formed protruded with a certain width.

38. The receiver unit of claim 35, wherein the sound leakage unit of the receiver unit has a certain width and is formed as a cylindrical type with a plurality of leakage holes in a circumferential direction, and both sides of which are respectively attached at a lower housing of the receiver and the inner case.
